(19) United States
(12) Patent Application Publication
(10) Pub. No.: US 2017/0175367 A1
(43) Pub. Date: Jun. 22, 2017

(54) Water Resource Control System At Home And Method Thereof

(71) Applicants: Inventec (Pudong) Technology Corporation, Shanghai (CN); Inventec Corporation, Taipei City (TW)

(72) Inventor: Jun Feng Zhu, Shanghai (CN)

(73) Assignee: Inventec Corporation, Taipei City (TW)

(21) Appl. No.: 15/073,489

(22) Filed: Mar. 17, 2016

(30) Foreign Application Priority Data
Dec. 17, 2015 (CN) 201510955139.6

(51) Int. Cl. E03B 7/07; G05B 15/02; H04L 29/06; E03C 1/242

(52) U.S. Cl. CPC E03B 7/071; E03C 1/242; E03B 7/072; G05B 15/02; H04L 67/42

(57) ABSTRACT

The present invention illustrates a water resource control system at home and a method thereof. In the system, a water pressure sensor and a flow sensor are respectively set up at a water outlet of a drain device and a bottom of the water outlet. A water pressure value and a flow value respectively measured by the water pressure sensor and the flow sensor are transmitted to a server. When the water pressure value is higher than a default pressure threshold and the flow value is higher than a default flow threshold, the server generates and transmits a water supply termination instruction to a control switch which is set up at a water inlet. The control switch then closes the water inlet according to the water supply termination instruction. Therefore, the technical effect of avoiding from wasting water resource can be achieved.

### CROSS-REFERENCE TO RELATED APPLICATION

This application claims the benefit of Chinese Patent Application No. 201510955139.6, filed Dec. 17, 2015.

### BACKGROUND OF THE INVENTION

Field of the Invention

The present invention generally relates to a control system and a method thereof, more particularly to a system capable of measuring a water pressure and a flow rate to control water resource at home and a method thereof.

Description of the Related Art

While water supply is stopped, people usually open faucets to check whether the water supply is restored. However, people often forget opening the faucet, which may waste water resource while the water supply is restored but people are not at home.

In conclusion, the water resource waste problem caused by the user who opens faucet to check whether the water supply is restored but forgets opening the faucet while not at home, exists in the conventional technology for a long-term period. What is need is to provide an improved technology solution to solve this problem.

### SUMMARY OF THE INVENTION

In order to solve the problem caused by the user who opens faucet to check whether the water supply is restored but forgets opening the faucet while not at home, the present invention provides a water resource control system at home and a method thereof.

The water resource control system includes a water pressure sensor, a flow sensor, a server and a control switch. The server includes a server receiving module, a generating module and a server transmitting module.

The water pressure sensor is set up at a water outlet of a drain device and configured to measure a water pressure value at the water outlet and transmit the water pressure value.

The flow sensor is set up at a bottom of the water outlet of the drain device and configured to measure a flow value at the bottom of the outlet and transmit the flow value.

The server receiving module is configured to receive the water pressure value and the flow value from the water pressure sensor and the flow sensor respectively. The generating module is configured to generate a water supply termination instruction when the water pressure value is higher than a default pressure threshold and the flow value is higher than a default flow threshold. The server transmitting module is configured to transmit the water supply termination instruction.

The control switch is set up at a water inlet. When receiving the water supply termination instruction from the server transmitting module, the control switch closes the water inlet according to the water supply termination instruction.

The present invention further provides a water resource control method at home, and the method includes following steps: setting up a water pressure sensor at a water outlet of a drain device, using the water pressure sensor to measure a water pressure value at the water outlet, and transmitting the water pressure value; setting up a flow sensor on a bottom of the water outlet of the drain device, using the flow sensor to measure a flow value at the bottom of the water outlet, and transmitting the flow value; receiving the water pressure value and the flow value from the water pressure sensor and the flow sensor by a server respectively; generating a water supply termination instruction when the water pressure value is higher than a default pressure threshold and the flow value is higher than a default flow threshold by the server; transmitting the water supply termination instruction from the server; setting up a control switch at a water inlet, and using the control switch to close the water inlet according to the water supply termination instruction after the control switch receives the water supply termination instruction from the server.

The difference between the system and method of the present invention between the conventional technology is that in the present invention the water pressure sensor and the flow sensor are respectively set up at the water outlet of the drain device and the bottom of the water outlet, and the water pressure value and the flow value respectively measured by the water pressure sensor and the flow sensor are transmitted to the server, and the server generates and transmits the water supply termination instruction to the control switch set up at the water inlet when the water pressure value is higher than the default pressure threshold and the flow value is higher than the default flow threshold, and the control switch closes the water inlet according to the water supply termination instruction.

By means of above-mentioned technology, the present invention can achieve the technical effect of preventing the water resource from being wasted.

### BRIEF DESCRIPTION OF THE DRAWINGS

The detailed structure, operating principle and effects of the present disclosure will now be described in more details hereinafter with reference to the accompanying drawings that show various embodiments of the present disclosure as follows.

FIG. 1 is a block diagram of a water resource control system at home, in accordance with the present invention.

FIGS. 2A and 2B are flow charts of a water resource control method at home, in accordance with the present invention.

FIG. 3 is a schematic structural view of the water resource control system at home, in accordance with the present invention.

### DETAILED DESCRIPTION

Reference will now be made in detail to the exemplary embodiments of the present disclosure, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

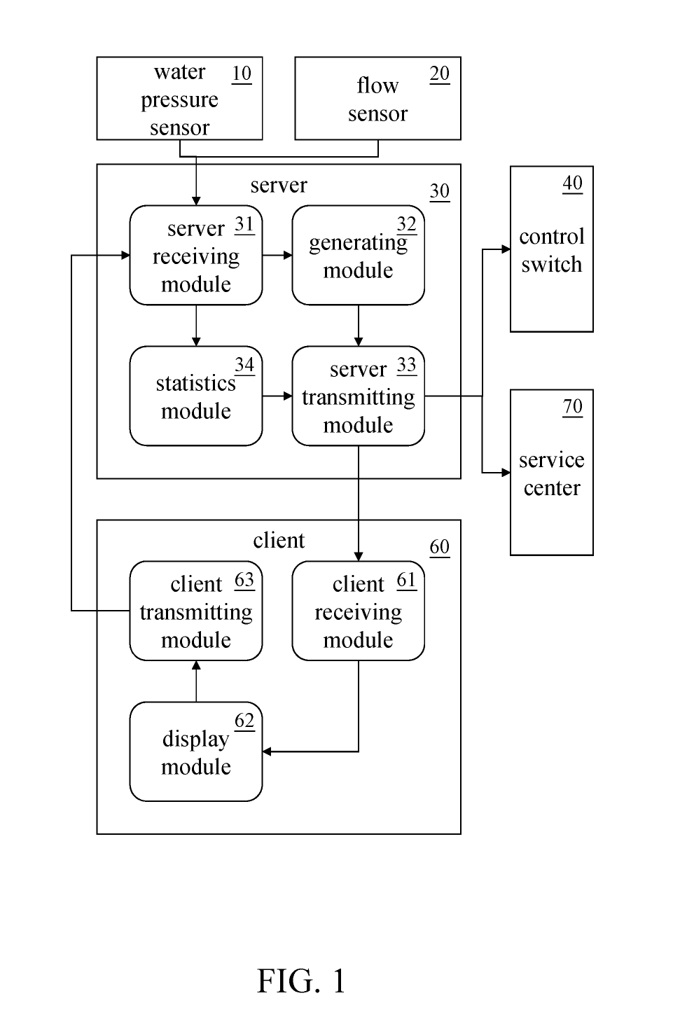

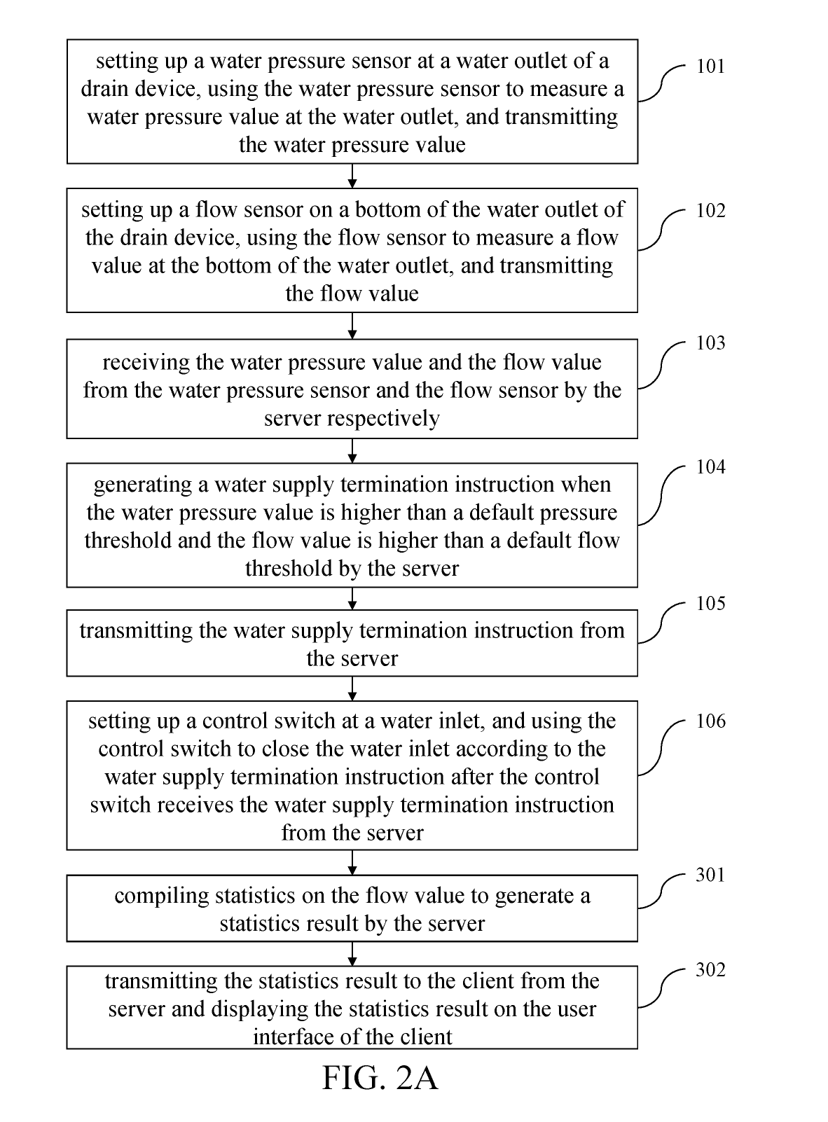

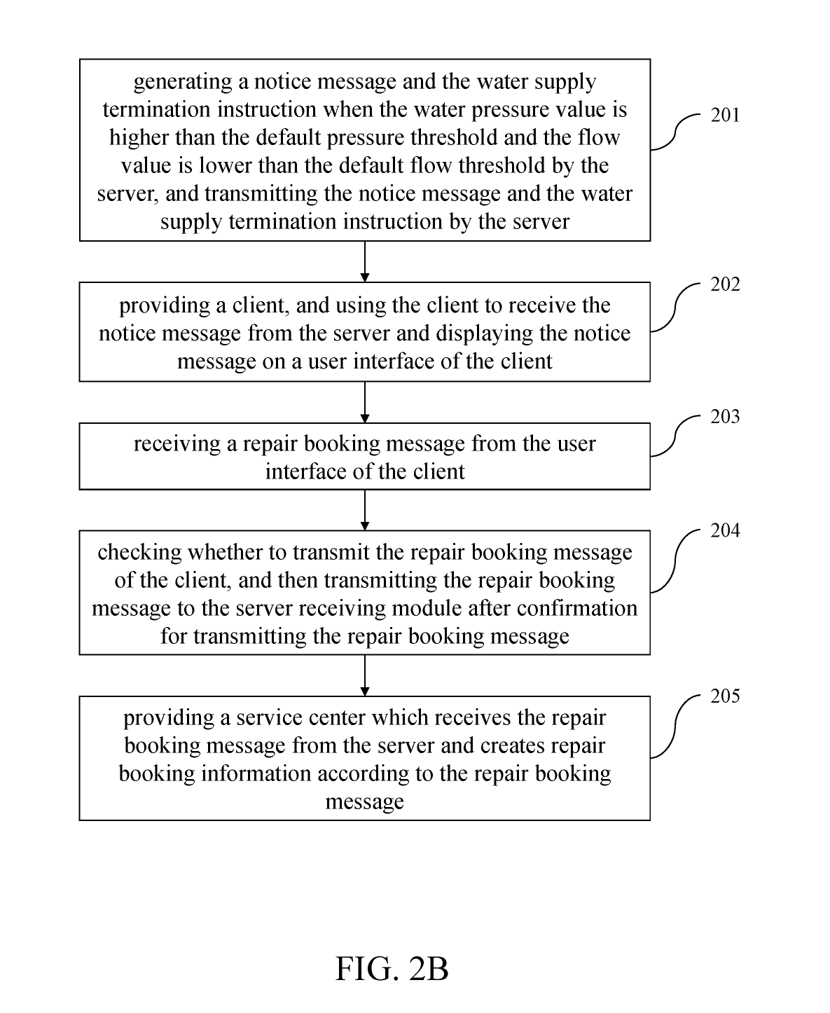

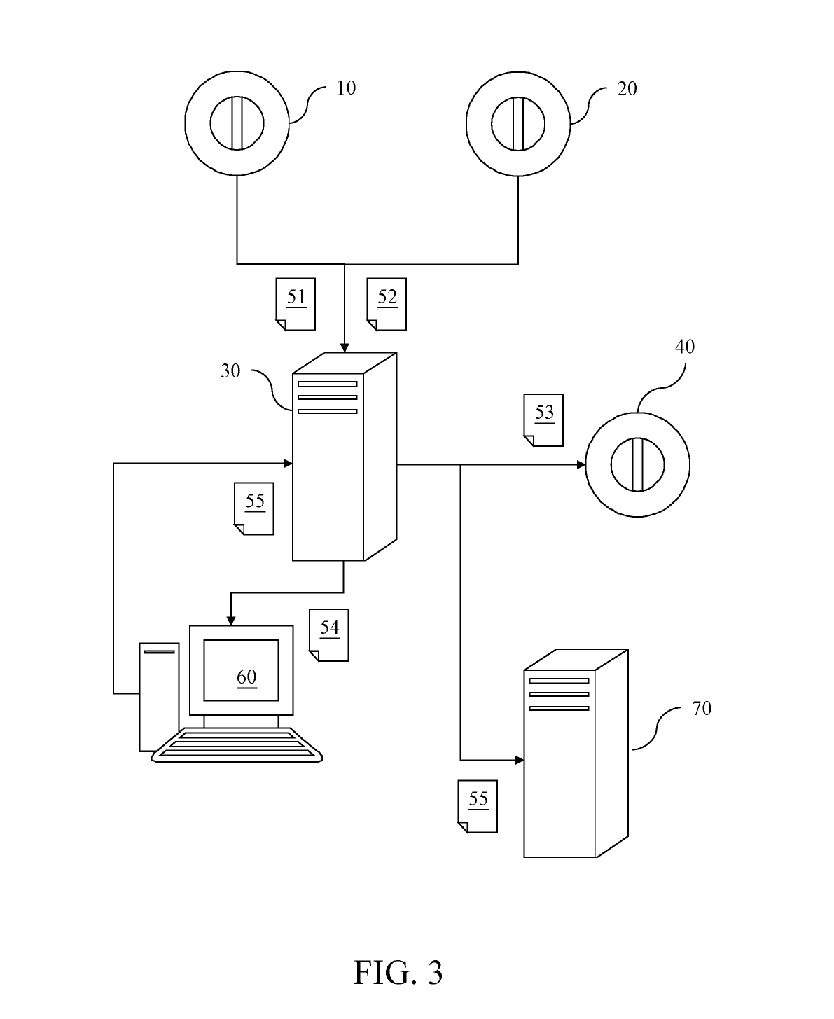

In following content, an embodiment is taken as an example to illustrate the water resource control system at home and method thereof, in accordance with the present invention. Please refer to FIGS. 1, 2A, 2B and 3 which respectively show block diagram of the water resource control system at home, flow charts of a water resource control, and schematic structural view of the water resource control method, in accordance with the present invention.

The water resource control system of the present invention includes a water pressure sensor 10, a flow sensor 20, a server 30 and a control switch 40. The server 30 further includes a server receiving module 31, a generating module 32 and a server transmitting module 33.

The water pressure sensor 10 is set up at an outlet of a drain device and configured to measure a water pressure value 51 at the outlet of the drain device and transmit the water pressure value 51 by a wireless transmission manner (in step 101). For example, the drain device can be a sink, and the wireless transmission manner may include wireless network, Wi-Fi, and so on, but the present invention is not limited thereto.

The flow sensor 20 is set up at a bottom of the outlet of the drain device and configured to measure a flow value 52 and transmit the flow value 52 by the wireless transmission manner (in step 102). For example, the wireless transmission manner may include wireless network, Wi-Fi, and so on, but the present invention is not limited thereto.

The server 30 is electrically connected with the water pressure sensor 10 and the flow sensor 20 and respectively receives the water pressure value 51 and the flow value 52 from the water pressure sensor 10 and the flow sensor 20 (in step 103). The server 30 establishes the connection with the water pressure sensor 10 and the flow sensor 20 by the wireless transmission manner. For example, the wireless transmission manner may include wireless network, Wi-Fi, and so on, but the present invention is not limited thereto.

After the server receiving module 31 receives the water pressure value 51 and the flow value 52 from the water pressure sensor 10 and the flow sensor 20 respectively, when the water pressure value 51 is higher than a default pressure threshold and the flow value 52 is higher than a default flow threshold, it indicates that the drain device is performing an abnormal drain, so the generating module 32 of the server 30 generates a water supply termination instruction 53 (step 104), to prevent the water resource from being wasted.

After being generated by the generating module 32 of the server 30, the water supply termination instruction is transmitted to the control switch 40 via the server transmitting module 33 of the server 30 by the wireless transmission manner (step 105). The control switch 40 is set up in a water inlet. For example, the water inlet can be located correspondingly in position to a faucet of the drain device or to a water meter, and the wireless transmission manner may include wireless network, Wi-Fi, and so on, but the present invention is not limited thereto. According to the water supply termination instruction 53, the control switch 40 closes the water inlet to stop the drain device draining, so as to prevent the water resource from being wasted.

In addition, when the water pressure value 51 is higher than the default pressure threshold and the flow value 52 is lower than the default flow threshold, it indicates that the drain device is performing the abnormal drain and the water outlet of the drain device is clogged, so the generating module 32 of the server 30 generates the water supply termination instruction 53 and a notice message 54 (step 201), to prevent the water resource from being wasted. For example, the notice message 54 can be a drain device error message and so on, but the present invention is not limited thereto.

After the generating module 32 of the server 30 generates the notice message 54 and the water supply termination instruction 53, the water supply termination instruction 53 is transmitted to the control switch 40 via the server transmitting module 33 of the server 30 by the wireless transmission manner, and the notice message 54 is transmitted to a client 60 via the server transmitting module 33 of the server 30 by the wireless transmission manner (step 201). For example, the wireless transmission manner may include wireless network, Wi-Fi and so on, the client 60 can be a computer, a notebook computer, a tablet computer, a hand-held device and so on, but the present invention is not limited thereto.

According to the water supply termination instruction 53, the control switch 40 closes the water inlet to stop the drain device draining, so as to prevent the water resource from being wasted.

A client receiving module 61 of the client 60 can receive the notice message 54 from the server transmitting module 33 of the server 30, and a display module 62 of the client 60 is configured to display the notice message 54 on a user interface (step 202), so that the user can be aware of the abnormality of the drain device.

Next, the user can further create a repair booking message 55 through the user interface. For example, the repair booking message 55 can include user information, booking time and so on, but the present invention is not limited thereto. The client receiving module 61 of the client 60 receives the repair booking message 55 (step 203), and a client transmitting module 63 of the client 60 then transmits the repair booking message 55 to the server 30.

After the server receiving module 31 of the server 30 receives the repair booking message 55 from the client transmitting module 63 of the client 60 and the client acknowledges the transmission of the repair booking message, the repair booking message 55 is transmitted to a service center 70 (step 204).

After receiving the repair booking message 55 from the server receiving module 31 of the server 30, the service center 70 creates repair booking information according to the repair booking message 55 (step 205), so that the user's booking for repairing the drain device is completed.

It is worth noting that the server 30 can further include a statistics module 34 configured to compile statistics on the flow value to generate a statistics result (step 301). After the statistics module 34 of the server 30 generates the statistics result, the server transmitting module 33 of the server 30 transmits the statistics result to the client 60. In the client 60, the client receiving module 61 of the client 60 receives the statistics result from the server transmitting module 33 of the server 30, and the display module 62 of the client 60 shows the statistics result on the user interface (step 302), so that the user can be aware of the usage condition of the water resource.

In conclusion, the difference between the present invention and the conventional technology is that the water pressure sensor and the flow sensor are respectively set up at the water outlet and bottom of the water outlet of the drain device, and the water pressure value and flow value respectively measured by the water pressure sensor and the flow sensor are transmitted to the server, and the server generates the water supply termination instruction when the water pressure value is higher than the default pressure threshold and the flow value is higher than the default flow threshold, and the water supply termination instruction is transmitted to the control switch set up at the water inlet, and the control switch then closes the water inlet according to the water supply termination instruction.

By means of the technology, the present invention can solve the water resource waste problem existing in the conventional technology and caused by the user who forgets opening the faucet for checking the restoration of water supply while not at home, so as to achieve the technical effect of preventing the water resource from being wasted.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

1. A water resource control system at home, comprising:
a water pressure sensor set up at a water outlet of a drain device and measuring a water pressure value at the water outlet and transmit the water pressure value;
a flow sensor set up at a bottom of the water outlet of the drain device and measuring a flow value at the bottom of the outlet and transmit the flow value;
a server, comprising:
a server receiving module receiving the water pressure value and the flow value from the water pressure sensor and the flow sensor respectively;
a generating module generating a water supply termination instruction when the water pressure value is higher than a default pressure threshold and the flow value is higher than a default flow threshold; and
a server transmitting module transmitting the water supply termination instruction; and
a control switch set up at a water inlet and closing the water inlet according to the water supply termination instruction upon receipt of the water supply termination instruction from the server transmitting module.

2. The water resource control system according to claim 1, wherein the generating module further generates a notice message and the water supply termination instruction when the water pressure value is higher than the default pressure threshold and the flow value is lower than the default flow threshold, and transmits the notice message and the water supply termination instruction through the server transmitting module.

3. The water resource control system according to claim 2, further comprising a client and a service center, wherein:
the client comprising:
a client receiving module receiving the notice message from the server transmitting module and a repair booking message from a user interface;
a display module displaying the notice message on the user interface; and
a client transmitting module check whether to transmit the repair booking message, and then transmit the repair booking message to the server receiving module after confirmation for transmitting the repair booking message; and
the service center receives the repair booking message from the server transmitting module and creates repair booking information according to the repair booking message.

4. The water resource control system according to claim 3, wherein the server further comprises a statistics module compile statistics on the flow value to generate a statistics result, and the server transmitting module transmits the statistics result to the client receiving module and the display module shows the statistics result on the user interface.

5. The water resource control system according to claim 1, wherein the water inlet corresponds in position to a faucet of the drain device or to a water meter.

6. A water resource control method at home, comprising:
setting up a water pressure sensor at a water outlet of a drain device, the water pressure sensor measuring a water pressure value at the water outlet, and transmitting the water pressure value;
setting up a flow sensor on a bottom of the water outlet of the drain device, the flow sensor measuring a flow value at the bottom of the water outlet, and transmitting the flow value;
receiving the water pressure value and the flow value from the water pressure sensor and the flow sensor by a server respectively;
generating a water supply termination instruction when the water pressure value is higher than a default pressure threshold and the flow value is higher than a default flow threshold by the server;
transmitting the water supply termination instruction from the server; and
setting up a control switch at a water inlet, and the control switch close the water inlet according to the water supply termination instruction after the control switch receives the water supply termination instruction from the server.

7. The water resource control method according to claim 6, further comprising:
generating a notice message and the water supply termination instruction when the water pressure value is higher than the default pressure threshold and the flow value is lower than the default flow threshold by the server, and transmitting the notice message and the water supply termination instruction by the server.

8. The water resource control method according to claim 7, further comprising:
providing a client, and the client receiving the notice message from the server and displaying the notice message on a user interface of the client;
receiving a repair booking message from the user interface of the client;
checking whether to transmit the repair booking message by the client, and then transmitting the repair booking message to the server after confirmation for transmitting the repair booking message; and
providing a service center which receives the repair booking message from the server and creates repair booking information according to the repair booking message.

9. The water resource control method according to claim 6, further comprising:
compiling statistics on the flow value to generate a statistics result by the server; and
transmitting the statistics result to the client from the server and displaying the statistics result on the user interface of the client.

10. The water resource control method according to claim 6, in the step of setting up the control switch at the water inlet, wherein the water inlet is located correspondingly in position to a faucet of the drain device or to a water meter.
